(19) United States
(12) Patent Application Publication
(10) Pub. No.: US 2014/0196070 A1
(43) Pub. Date: Jul. 10, 2014

(54) SYSTEM AND METHOD FOR AUTOMATED BROADCAST MEDIA IDENTIFICATION

(71) Applicant: SMRTV, INC., Emeryville, CA (US)

(72) Inventors: Alan Moskowitz, Emeryville, CA (US); Randall Cook, Emeryville, CA (US); Joe Addalia, Emeryville, CA (US)

(73) Assignee: SMRTV, INC., Emeryville, CA (US)

(21) Appl. No.: 13/735,968

(22) Filed: Jan. 7, 2013

(51) Int. Cl. H04N 21/44

(52) U.S. Cl. CPC H04N 21/44008
USPC 725/19

(57) ABSTRACT

An media identification system, operable by a network entity, receives media data for broadcast program segments including at least one of video data or audio data. The media identification system encodes a reference fingerprint based on the media data and receives a program log associated with the media data, the program log including segment names and broadcast times for the broadcast program segments. The media identification system associates the reference fingerprint with a segment name for a program segment based at least in part on the program log.

### BACKGROUND

1. Field

The present disclosure relates to broadcast content processing, and more particularly to automated identification of broadcast media.

2. Background

Digital fingerprinting technologies and devices are to label or identify television and radio broadcasts. Video/audio fingerprinting may be used to identify, extract, and store characteristics of video or audio data into a fingerprint, enabling video or audio data to be uniquely identified by its respective fingerprint. The identification of television and radio broadcasts allows a content provider to provide relevant information to a user based on what the user is currently watching or listening.

One known approach of identifying television and radio broadcasts involves having humans manually identify each program and label fingerprints created from the program, which may be slow and prone to human errors. In this context, there remains a need for automating and improving the accuracy of the identification of broadcast media segments.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, there is provided a media identification system that may receive media data for broadcast program segments including at least one of video data or audio data. The media identification system may encode a reference fingerprint based on the media data and may receive a program log associated with the media data, the program log including segment names and broadcast times for the broadcast program segments. The media identification system may associate the reference fingerprint with a segment name for a program segment based at least in part on the program log. The media identification system may include one or more network entities to perform the above described tasks in a centralized and/or distributed manner.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a block diagram illustrating an example of a system for automated broadcast media identification.

FIG. 2A illustrates an example automated broadcast media identification methodology.

FIG. 2B shows further aspects of the methodology of FIG. 2A.

FIG. 3A illustrates an embodiment of an apparatus for automated broadcast media identification.

FIG. 3B shows further aspects of the apparatus for automated broadcast media identification of FIG. 3A.

FIG. 4 illustrates a flowchart for a method for automated broadcast media identification.

FIG. 5 illustrates a second flowchart for a method for automated broadcast media identification.

### DETAILED DESCRIPTION

Various aspects are described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

System and methods for automated broadcast media identification are described herein. As used herein, broadcast media generally refers to television and/or radio content transmitted through cable or over the air. The broadcast media may include digital or analog data signals. The broadcast media may include audio and video content that is organized into scheduled or unscheduled program segments. The broadcast media typically does not include metadata identifying the program segments. Without proper identification of the program segments, it is difficult to deliver content relevant to the program segment to a viewer of the broadcast media.

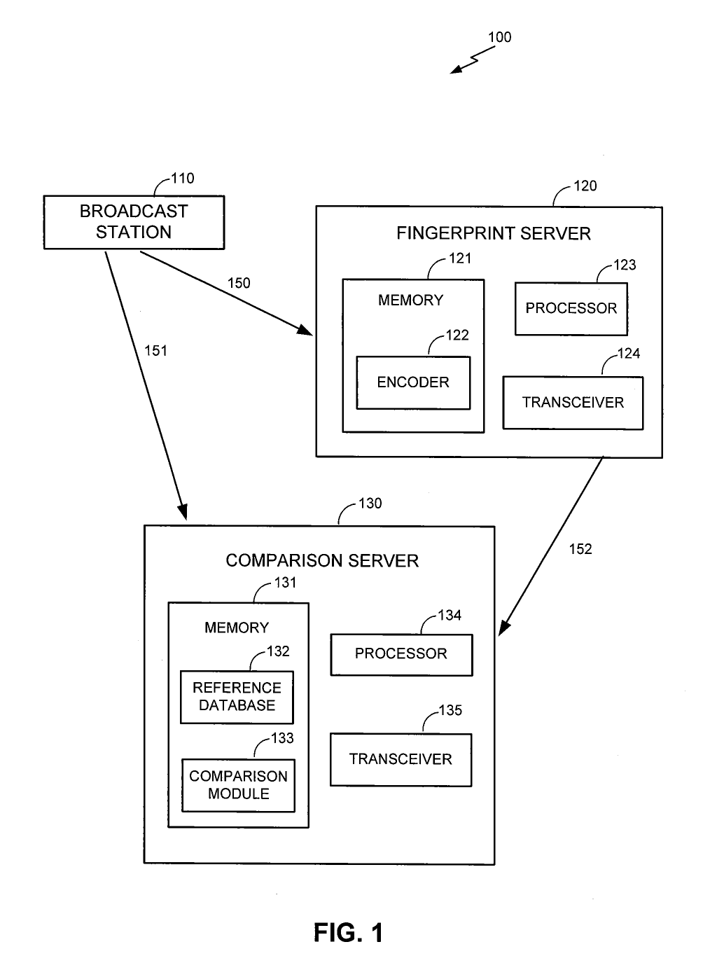

FIG. 1 shows an example system 100 in accordance with one or more aspects of the embodiments described herein. A broadcast station 110 transmits media data 150 to a fingerprint server 120. The broadcast station 110 may be a base station including a transmitter for broadcasting the media data. The broadcast station 110, for example, may be a television system broadcasting the media data 150 on a television channel over the air or through cable. Although FIG. 1 illustrates one block to represent the broadcast station 110, it is understood that the broadcast station 110 may refer to more than one facility located in different geographic areas. It is further understood that the one or more broadcast stations 110 may simultaneously transmit media data 150 over a plurality of channels or frequencies. For example, a different television program segment may be transmitted on each of a plurality of television channels.

The media data 150 may include at least one of audio or video data. The transmission may be continuous or may start and stop over periods of time. The media data 150 may be in either analog or digital format. Example analog television systems, which are encoding or formatting standards, in current use are NTSC, PAL, and SECAM. In related aspects, digital television systems may use the MPEG transport stream format or the like.

The fingerprint server 120 may be configured to encode the media data 150 into reference fingerprints 152. A fingerprint may be a compressed representation of a piece of media data. The fingerprint may act as a signature that summarizes and identifies a piece of media data. In one approach, each piece of media data represented by a reference fingerprint 152 may be a single frame of video of the media data 150. In another approach, each piece of media data represented by a reference fingerprint 152 may be an audio segment of the media data. In a third approach, each piece of media data represented by a reference fingerprint 152 may be a video segment in combination with a contemporaneous audio segment of the media data 150.

An ideal fingerprinting system will fulfill several requirements. The fingerprint should allow discrimination over a vast number of other fingerprints to uniquely identify a piece of media data. It should be robust at ignoring distortion of the media data from compression and interference. The fingerprint should also be compact to facilitate storage of the vast number of fingerprints. The fingerprint should be computationally simple to encode to reduce the use of processor resources. Encoding the fingerprint involves taking a set of samples from the media data and using a fingerprint model to encode the samples into a fingerprint representation. For example, a fingerprint representation may be in the form of a vector, a trace of vectors, a codebook, or a sequence of indexes.

As media data 150 is continuously received by the fingerprint server 120, the fingerprint server 120 encodes corresponding reference fingerprints 152 from the media data 150. Each reference fingerprint 152 may correspond to an individual fingerprint file or may represent a portion of a combined fingerprint file containing a plurality of reference fingerprints 152.

In one approach, a timestamp may be added to each of the reference fingerprint 152. In these aspects, the reference fingerprint 152 refers to the combination of encoded media data and the timestamp. The timestamp may refer to the time that the piece of media data corresponding to the reference fingerprint 152 is broadcasted from the broadcast station 110.

The fingerprint server 120 may include a transceiver 124 configured to receive the media data 150 from the broadcast station 110 and to transmit the reference fingerprints 152. A standalone receiver and/or standalone transmitter may be used in lieu of or in conjunction with the transceiver 124. The fingerprint server 120 may optionally include a component for storing information, such as, for example, a memory device/component 121. The memory 121 may be configured to store computer readable instructions and data. An encoder 122 may be stored as computer readable instructions in the memory 121. The fingerprint server 120 may include a processor 123 configured to be able to read information from, write information to, the memory 121. The processor 123 may be configured to execute the encoder 122 instructions stored on the memory 121 to encode the media data 150 into reference fingerprints 152. While shown as being external to the memory 121, it is to be understood that the components 123 and 124 can exist within the memory 121. It is further noted that the components of the fingerprint server in FIG. 1 may comprise electronic devices, hardware devices, electronic sub-components, logical circuits, memories, software codes, firmware codes, etc., or any combination thereof.

The fingerprint server 120 may be configured transmit the reference fingerprints 152 to a comparison server 130. In addition, the broadcast station 100 may transmit a program log 151 to the comparison server 130. The program log 151 may be a playlist of the broadcast from the broadcast station 110. The program log 151 provides information on which program segments were broadcasted or will be broadcasted. The program log 151 may provide a segment name corresponding to each of the program segments. The program log 151 also provides broadcast times for the program segments, which may include a combination of a start time, a stop time, and duration corresponding to each of the program segments. The program log 151 may be in the form of a list or table of the segment names and their broadcast times. The program log 151 may include information on program segments previously broadcasted, program segments scheduled for the future, or program segments currently broadcasting. The program log 151 may be transmitted from the broadcast station 110 after the broadcast of the program segments or transmitted before the broadcast of the program segments. The program log 151 may be periodically transmitted and updated during the broadcast of the program segments or continuously transmitted and updated. Typically, a program log 151 that is transmitted before the broadcast of the program segments may have some errors as it is not always possible to perfectly predict the broadcast times of the program segments to be broadcasted in the future. For example, this error may be the result of news programs and other live broadcasts in which the program segment may go over or under its allotted time. A program log 151 that is transmitted after the broadcast of the program segments is sometimes referred to as a reconciliation file. Reconciliation files, as they are available after the broadcast of the program segments may be more accurate with little to no errors as they are only a log of past events. In instances where accuracy of the program log 151 is of paramount importance, reconciliation files may be preferred.

A comparison server 130 may be configured to associate the reference fingerprints 152 with a segment name for a program segment based at least in part on the program log 151. In one approach, the timestamp of a reference fingerprint 152 may be matched with a broadcast time in the program log 151. The reference fingerprint 152 corresponding to the timestamp may then associated with the segment name with the matching broadcast time in the program log 151. In related aspects where the program log 151 contains segment names and broadcast times for a set period of time, the comparison server 130 may associate segment names to all the reference fingerprints 152 corresponding to the pieces of media data broadcasted during the same set period of time. For example, if the program log 151 contains segment names and broadcast times to program segments for a previous twenty-four hours of broadcasting, all the reference fingerprints 152 corresponding those twenty-four hours of broadcasting will be associated with segment names.

The comparison server may include a transceiver 135 configured to receive the program log 151 from the broadcast station 110 and the reference fingerprints 152 from the fingerprint server 120. A standalone receiver and/or standalone transmitter may be used in lieu of or in conjunction with the transceiver 135. The comparison server 130 may optionally include a component for storing information, such as, for example, a memory device/component 131. The memory 131 may be configured to store computer readable instructions and data. A reference database 132 may be stored in the memory 131. The reference database 132 stores a set of reference fingerprints 152 and their associated segment names. A comparison module 133 may be stored as computer readable instructions in the memory 131. The comparison server 130 may include a processor 134 configured to be able to read information from, write information to, the memory 131. The processor 134 may be configured to execute the comparison module 133 instructions stored on the memory 131 to associate the reference fingerprints 152 with segment names based at least in part on the program log 151. While shown as being external to the memory 131, it is to be understood that the components 134 and 135 can exist within the memory 131. It is further noted that the components of the comparison server in FIG. 1 may comprise electronic devices, hardware devices, electronic sub-components, logical circuits, memories, software codes, firmware codes, etc., or any combination thereof.

In related aspects, the comparison server 130 is configured to search for a repeated reference fingerprint in the reference database 132. An existence of the repeated reference fingerprint indicates a repeated program segment. To illustrate, a particular automotive commercial that is broadcasted several times may be an example of a repeated program segment. Short repeated program segments spanning fifteen or thirty seconds may strongly suggest commercial advertisements while longer repeated program segments may indicate scheduled programming. The repeated reference fingerprint is a reference fingerprint 152 that matches a previously encoded reference fingerprint. A previously encoded reference fingerprint may be defined as a reference fingerprint 152 with a timestamp at least a set period of time prior to a timestamp of a reference fingerprint 152 used in comparison. For example, the set period of time may be configured to be ten minutes to prevent repeated video or audio from a single commercial advertisement to create repeated reference fingerprints. In one approach, the repeated reference fingerprints are given particular importance as they are more likely to be associated with a program segment that will be broadcasted again in the future.

It is noted that the broadcast station 110, the fingerprint server 120, and the comparison server 130 are each shown as separate identities in FIG. 1, but any combination thereof may exist as a combined entity. For example, the fingerprint server 120 may be combined with the comparison server 130 and may share hardware and software components with the comparison server 130. The fingerprint server 120 may be conceivably located onsite at the broadcast station 110 or may be located offsite. Similarly, the comparison server 130 may be conceivably located onsite at the broadcast station 110 or may be located offsite. It is further noted that the fingerprint server 120 and the comparison server 130 may each include one or multiple electronic devices located at one or multiple locations.

In one approach, content related to a program segment of a broadcast media may be sent to a user equipment (e.g., a smartphone, mobile personal computing device, or the like) that a user is currently watching or listening to. For example, a user watching a soda commercial on television may be sent content related to the brand of soda in the commercial, content such as locations of nearby retail stores that carry that brand of soda.

In related aspects, generalized content may be sent to the user equipment based at least in part on a segment name associated with a currently broadcasted program segment. The generalized content may include content related to only those program segments that are currently broadcasted. For example, content related to a plurality of currently broadcasted program segments on different channels may all be sent to the user device. A user may then pick and choose which content the user wishes to view.

In further related aspects, targeted content may be transmitted to the user equipment based on a given segment name, where the given segment name is associated with a specific program segment that the user is currently watching or listening to. In one approach, the user equipment may manually communicate to the comparison server 130 information regarding which specific channel or broadcast station that the user is currently watching or listening to. For example, the user may input a channel number with a keypad on the user equipment, which is then transmitted to the comparison server 130. The comparison server 130 may then search for a given segment name associated with the currently watched or listened to broadcast program segment. The comparison server 130 may then transmit content based at least in part on the given segment name to the user equipment.

In a second approach, a query reference fingerprint may be based at least in part on samples taken by the user device. The samples taken by the user device are the similar to those taken by the fingerprint server 120 for encoding fingerprints (e.g. a still frame capture from a video recording, an audio segment capture). The user device may encode the query reference fingerprint locally or may send the samples to be encoded into a query reference fingerprint remotely. The comparison server 130 searches for a given reference fingerprint in the reference database 132 that matches with the query reference fingerprint. If the given reference fingerprint is found, then content based at least in part on the given segment name may then be transmitted to the user equipment. This method eliminates the need for the user to manually input information regarding the channel or frequency the user is watching or listening to.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

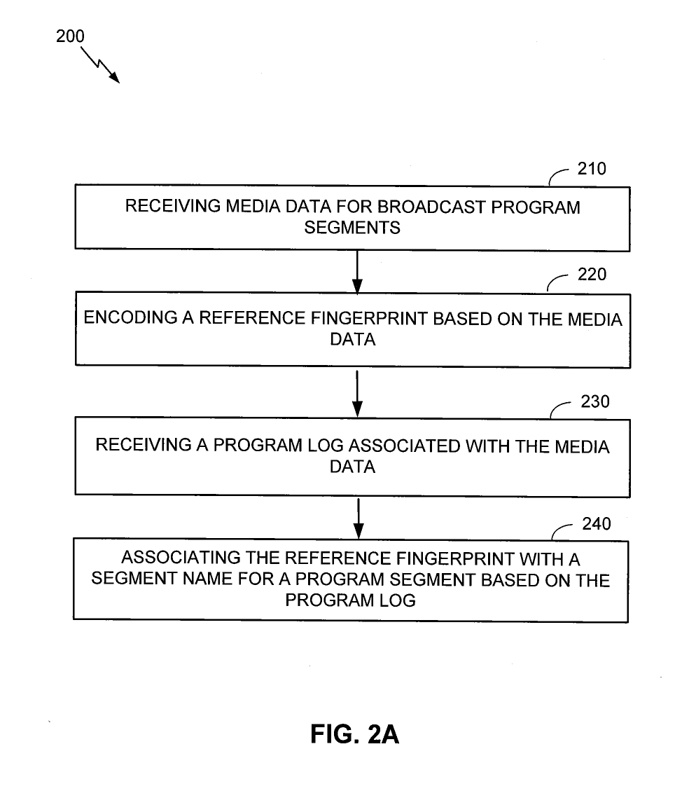

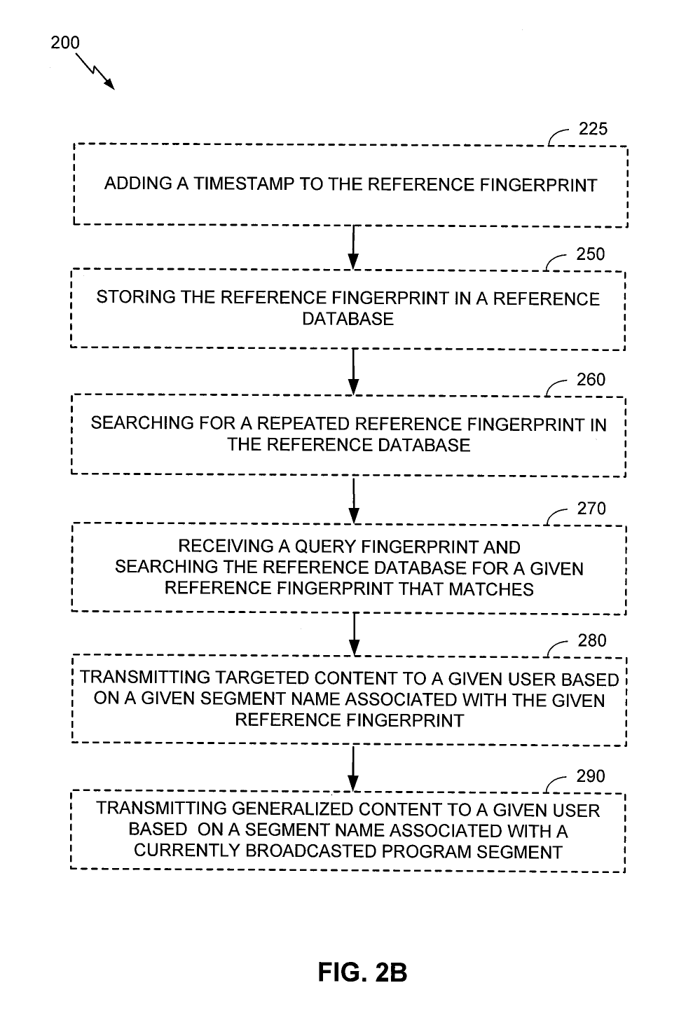

In accordance with one or more aspects of the embodiments described herein, with reference to FIG. 2A, there is shown a methodology 200 for automated broadcast media identification, operable by a network entity. The method 200, operable by the network entity or the like or component(s) thereof, may involve, at 210, receiving media data 150 for broadcast program segments including at least one of video data or audio data. The method 200 may involve, at 220, encoding a reference fingerprint 152 based on the media data. The method 200 may involve, at 230, receiving a program log 151 associated with the media data 150, the program log 151 including segment names and broadcast times for the broadcast program segments. The method 200 may involve, at 240, associating the reference fingerprint 152 with a segment name for a program segment based at least in part on the program log 151.

FIG. 2B show further optional operations or aspects of the method 200 described above with reference to FIG. 2A. If the method 200 includes at least one block of FIGS. 2A, then the method 200 may terminate after the at least one block, without necessarily having to include any subsequent downstream block(s) that may be illustrated. It is further noted that numbers of the blocks do not imply a particular order in which the blocks may be performed according to the method 200.

The method 200 may involve, at 225, adding a timestamp to the reference fingerprint 152. In related aspects, the method 200 may involve, at 250, storing the reference fingerprint 152 in a reference database 132; and at 260, searching for a repeated reference fingerprint 152 in the reference database 132. The method 200 may further involve, at 270, receiving a query fingerprint and searching the reference database 132 for a given reference fingerprint that matches the query fingerprint; and at 280, transmitting targeted content to a given user based on a given segment name associated with the given reference fingerprint. In other aspects, the method 200 may involve, at 290, transmitting generalized content to a given user based on a segment name associated with a currently broadcasted program segment.

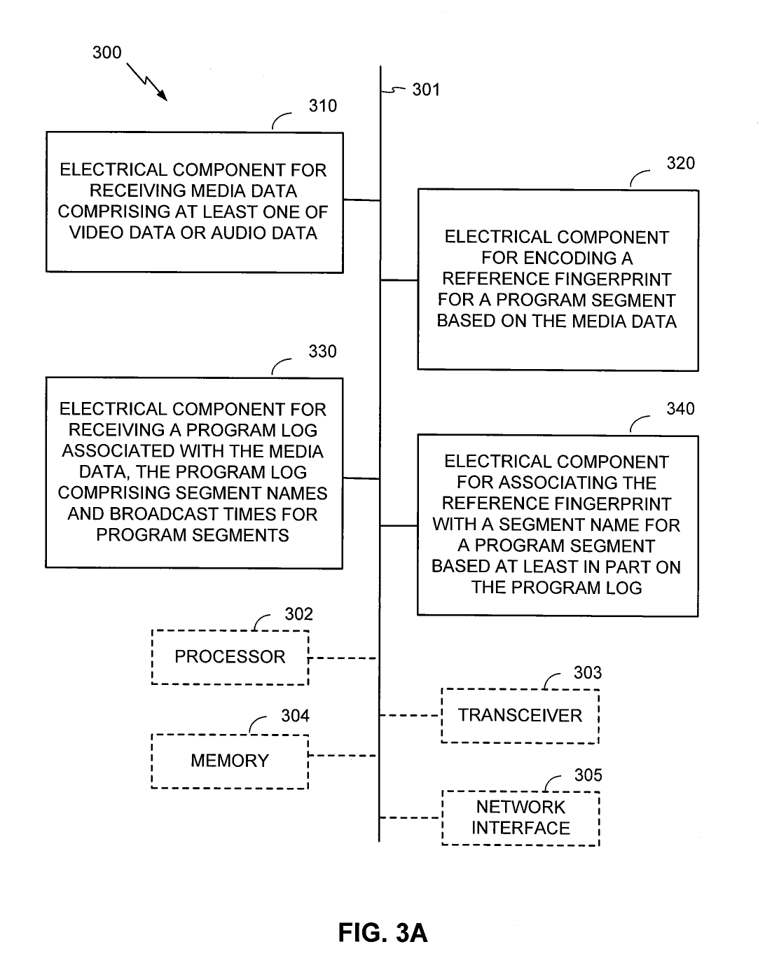

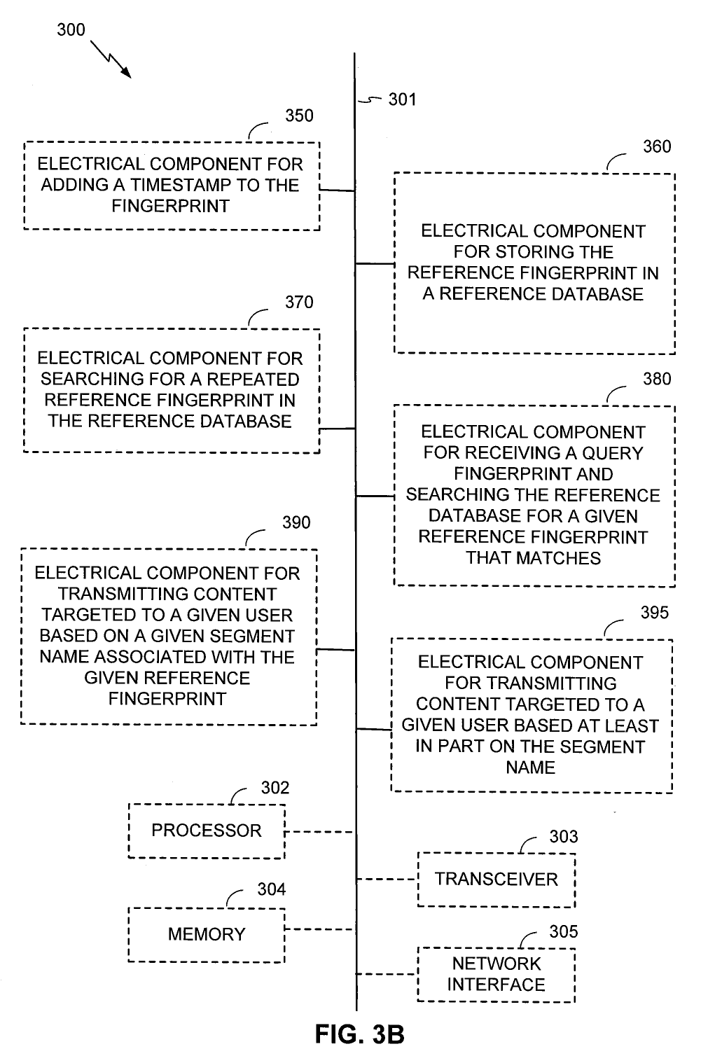

In accordance with one or more aspects of the embodiments described herein, FIG. 3A shows a design of an apparatus 300 for automated broadcast media identification. The exemplary apparatus 300 may be configured as a computing device or as a processor or similar device/component for use within. In one example, the apparatus 300 may include functional blocks that can represent functions implemented by a processor, software, or combination thereof (e.g., firmware). In another example, the apparatus 300 may be a system on a chip (SoC) or similar integrated circuit (IC).

In one embodiment, apparatus 300 may include an electrical component or module 310 for receiving media data 150 comprising at least one of video data or audio data. For example, the component 310 may include the transceiver 124 working with the other components of the fingerprint server 120 shown in FIG. 1.

The apparatus 300 may include an electrical component 320 for encoding a reference fingerprint for a program segment based on the media data 150. For example, the component 320 may include the encoder 122 of the fingerprint server 120 shown in FIG. 1.

The apparatus 300 may include an electrical component 330 for receiving a program log 151 associated with the media data 150, the program log 151 comprising segment names and broadcast times for the program segments. For example, the component 330 may include the transceiver 135 of the comparison server 130 shown in FIG. 1.

The apparatus 300 may include an electrical component 340 for receiving a program log 151 associated with the media data 150, the program log 151 comprising segment names and broadcast times for the program segments. For example, the component 330 may include the transceiver 135 of the comparison server 130 shown in FIG. 1.

In related aspects, as described in FIG. 3B, the apparatus 300 may optionally include an electrical component 350 for adding a timestamp to the fingerprint. The apparatus 300 may optionally include an electrical component 360 for storing the reference fingerprint 152 in a reference database 132. The apparatus 300 may optionally include an electrical component 370 for searching for a repeated reference fingerprint in the reference database 132. The apparatus 300 may optionally include an electrical component 380 for storing the reference fingerprint 152 in a reference database 132. The apparatus 300 may optionally include an electrical component 380 for receiving a query fingerprint and searching the reference database 132 for a given reference fingerprint that matches the query fingerprint. The apparatus 300 may optionally include an electrical component 390 for transmitting content targeted to a given user based on a given segment name associated with the given reference fingerprint. The apparatus 300 may optionally include an electrical component 395 for transmitting content targeted to a given user based at least in part on the segment name.

In further related aspects, the apparatus 300 may optionally include a processor component 302. The processor 302 may be in operative communication with the components 310-395 via a bus 301 or similar communication coupling. The processor 302 may effect initiation and scheduling of the processes or functions performed by electrical components 310-395.

In yet further related aspects, the apparatus 300 may include a radio transceiver component 303. A standalone receiver and/or standalone transmitter may be used in lieu of or in conjunction with the transceiver 303. The apparatus 300 may also include a network interface 305 for connecting to one or more other communication devices or the like. The apparatus 300 may optionally include a component for storing information, such as, for example, a memory device/component 304. The computer readable medium or the memory component 304 may be operatively coupled to the other components of the apparatus 300 via the bus 301 or the like. The memory component 304 may be adapted to store computer readable instructions and data for effecting the processes and behavior of the components 310-395, and subcomponents thereof, or the processor 302, or the methods disclosed herein. The memory component 304 may retain instructions for executing functions associated with the components 310-395. While shown as being external to the memory 304, it is to be understood that the components 310-395 can exist within the memory 304. It is further noted that the components in FIGS. 3A and 3B may comprise processors, electronic devices, hardware devices, electronic sub-components, logical circuits, memories, software codes, firmware codes, etc., or any combination thereof.

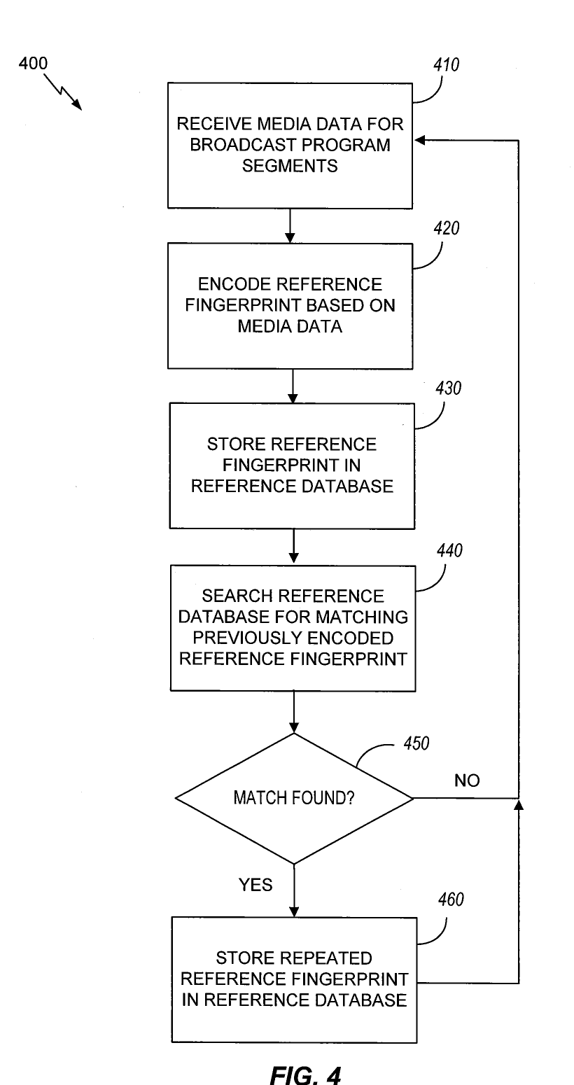

FIG. 4 illustrates a flowchart of an exemplary method of automated broadcast media identification. The method 400 may involve, at block 410, receiving media data 150 for broadcast program segments. The method 400 may involve, at block 420, encoding a reference fingerprint 152 based on the media data 150. The method 400 may involve, at block 430, storing the reference fingerprint 152 in a reference database 132. The method 400 may involve, at block 440, searching the reference database 132 for a repeated reference fingerprint that matches a previously encoded reference fingerprint. If a matching previously encoded reference fingerprint is found at block 450, storing the repeated reference fingerprint in the reference database 132 at block 460. If a matching previously encoded reference fingerprint is not found at 450, repeating the process from block 410.

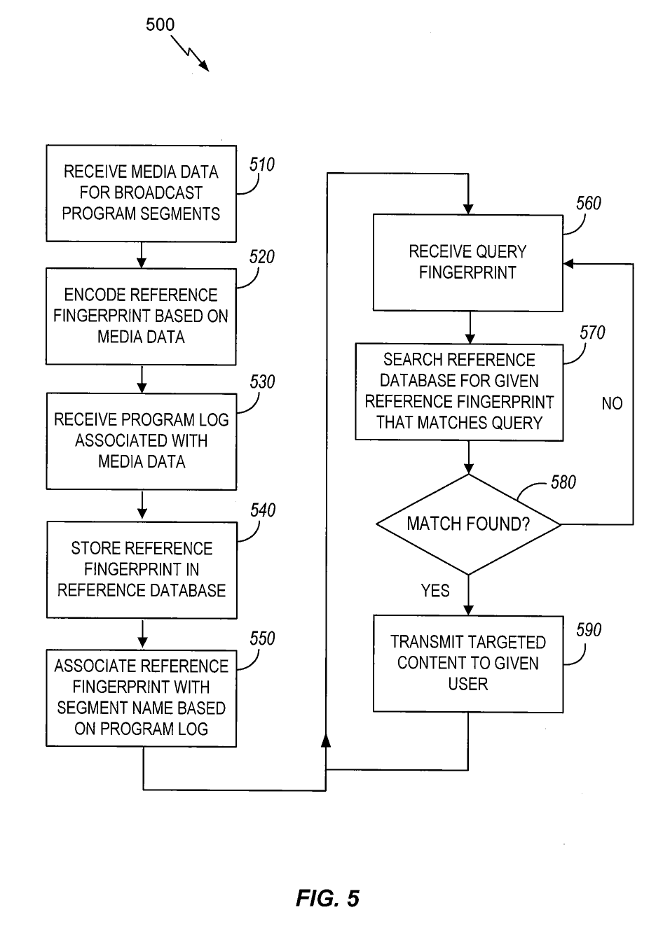

FIG. 5 illustrates a flowchart of another exemplary method of automated broadcast media identification. The method 500 may involve, at block 510, receiving media data 150 for broadcast program segments. The method 500 may involve, at block 520, encoding a reference fingerprint 152 based on the media data 150. The method 500 may involve, at block 530, receiving a program log associated with the media data 150. The method 500 may involve, at block 540, storing the reference fingerprint 152 in a reference database 132. The method 500 may involve, at block 550, associating the reference fingerprint 152 with a segment name based on the program log 151. The method 500 may involve, at block 560, receiving a query fingerprint. The method 500 may involve, at block 570, searching the reference database 132 for a given reference fingerprint that matches the query fingerprint. If a matching given reference fingerprint is found at block 580, transmitting targeted content to a given user at block 590. If a matching given reference fingerprint is not found at 580, repeating the process from block 560.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for automated broadcast media identification, operable by a network entity, comprising:
receiving media data for broadcast program segments comprising video data or audio data;
encoding a reference fingerprint based on the media data;
recording a timestamp for the reference fingerprint;
receiving a program log comprising segment names and broadcast times for the broadcast program segments, wherein each segment name corresponds to a broadcast time; and
determining a matching segment name from the program log for the reference fingerprint based at least in part on matching the timestamp to the broadcast times.

2. The method of claim 1, further comprising storing the reference fingerprint in a reference database.

3. The method of claim 2, further comprising searching for a repeated reference fingerprint in the reference database, wherein the repeated reference fingerprint matches a previously encoded reference fingerprint and indicates a repeated program segment.

4. The method of claim 2, further comprising:
receiving a query fingerprint; and
searching the reference database for a given reference fingerprint that matches the query fingerprint.

5. The method of claim 4, further comprising transmitting targeted content to a given user based at least in part on a given segment name for the given reference fingerprint.

6. The method of claim 1, further comprising transmitting generalized content to a given user based at least in part on a segment name for a currently broadcasted program segment.

7. (canceled)

8. The method of claim 1, wherein the media data comprises a plurality of discrete broadcast programs.

9. The method of claim 8, wherein the program log comprises a segment name and a broadcast time for each of the plurality of discrete broadcast programs.

10. The method of claim 8, wherein the plurality of discrete broadcast programs are broadcasted before the receiving of the program log.

11. The method of claim 8, wherein the plurality of discrete broadcast programs are broadcasted after the receiving of the program log.

12. The method of claim 1, wherein the encoding of the reference fingerprint based on the media data is continuous.

13. The method of claim 1, wherein the receiving the media data comprises receiving the media data from a plurality of channels.

14. The method of claim 1, wherein the reference fingerprint is encoded based at least in part on a video frame of the media data.

15. The method of claim 1, wherein the reference fingerprint is encoded based at least in part on an audio segment of the media data.

16. The method of claim 1, wherein the program log comprises a segment metadata for each of the segment names.

17. The method of claim 1, wherein the network entity comprises at least one of a broadcast reception server or a fingerprint comparison server.

18. The method of claim 17, wherein the broadcast reception server receives the media data and encodes the reference fingerprint.

19. The method of claim 17, wherein the fingerprint comparison server receives the program log and matches the reference fingerprint with a segment name.

20. The method of claim 17, wherein at least one of the broadcast reception server or the fingerprint comparison server is located at a broadcast station.

21. The method of claim 17, wherein at least one of the broadcast reception server and the fingerprint comparison server is located at a remote station.

22. An apparatus, comprising:
a receiver configured to:
receive media data comprising at least one of video data or audio data; and
receive a program log comprising segment names and broadcast times for program segments, wherein each segment name corresponds to a broadcast time; and
at least one processor configured to:
record a timestamp for the reference fingerprint;
encode a reference fingerprint for a program segment based on the media data; and
determining a matching segment name from the program log for the reference fingerprint based at least in part on matching the timestamp to the broadcast times; and
a memory coupled to the at least one processor for storing data.

23. An apparatus, comprising:
means for receiving media data comprising at least one of video data or audio data;
means for encoding a reference fingerprint for a program segment based on the media data;
means for recording a timestamp for the reference fingerprint;
means for receiving a program log comprising segment names and broadcast times for program segments, wherein each segment name corresponds to a broadcast time; and.

24. The apparatus of claim 23, further comprising means for storing the reference fingerprint in a reference database.

25. The apparatus of claim 24, further comprising means for searching for a repeated reference fingerprint in the reference database, wherein the repeated reference fingerprint matches a previously encoded reference fingerprint and indicates a repeated program segment.

26. The apparatus of claim 24, further comprising:
means for receiving a query fingerprint; and
means for searching the reference database for a given reference fingerprint that matches the query fingerprint.

27. The apparatus of claim 26, further comprising means for transmitting targeted content to a given user based at least in part on a given segment name for the given reference fingerprint.

28. A computer program product, comprising:
a non-transitory computer-readable medium comprising code for causing at least one computer to:
receive media data comprising at least one of video data or audio data;
encode a reference fingerprint for a program segment based on the media data;
record a timestamp for the reference fingerprint;
receive a program log comprising segment names and broadcast times for program segments, wherein each segment name corresponds to a broadcast time; and
determining a matching segment name from the program log for the reference fingerprint based at least in part on matching the timestamp to the broadcast times.

29. The computer program product of claim 28, wherein the computer-readable medium further comprises code for storing the reference fingerprint in a reference database.

30. The computer program product of claim 29, wherein the computer-readable medium further comprises code for searching for a repeated reference fingerprint in the reference database, wherein the repeated reference fingerprint matches a previously encoded reference fingerprint and indicates a repeated program segment.

31. The computer program product of claim 29, wherein the computer-readable medium further comprises:
code for receiving a query fingerprint; and
code for searching the reference database for a given reference fingerprint that matches the query fingerprint.

32. The computer program product of claim 31, wherein the computer-readable medium further comprises code for transmitting targeted content to a given user based at least in part on a given segment name associated with for the given reference fingerprint.
